(19) United States
(12) Patent Application Publication
(10) Pub. No.: US 2019/0023484 A1
(43) Pub. Date: Jan. 24, 2019

(54) CONTAINING SYSTEM

(71) Applicant: Myeong Ill SHIN, Jeonju-si, Jeollabuk-do (KR)

(72) Inventor: Myeong Ill SHIN, Jeonju-si, Jeollabuk-do (KR)

(21) Appl. No.: 15/759,081

(22) PCT Filed: Jun. 3, 2016
(86) PCT No.: PCT/KR2016/005872

§ 371 Date: Mar. 9, 2018

(30) Foreign Application Priority Data
Sep. 9, 2015 (KR) 10-2015-0127702

(51) Int. Cl. B65D 88/28; B65D 88/32; B65D 90/20; B65D 90/32; F16K 17/02

(52) U.S. Cl. CPC B65D 88/28; B65D 88/32; F16K 17/02; B65D 90/32; B65D 90/20

(57) ABSTRACT

Provided is a containing system which includes a first frame structure, a plurality of first discharge units in the first frame structure, extending in a first direction, and fixedly coupled to the first frame structure in a second direction perpendicular to the first direction, a second frame structure detachably coupled to the first frame structure in the first direction, a first containing unit fixedly supported on the second frame structure and spaced apart from the first frame structure, a second containing unit connected to the first containing unit and spaced apart from the first frame structure, a plurality of second discharge units connected to the second containing unit, aligned with the first discharge units in the first direction, and spaced apart from the first discharge units, and a pressure control unit connected to the first containing unit and controlling a first air pressure in the first containing unit to counterbalance a second air pressure outside the first containing unit.

### TECHNICAL FIELD

The present disclosure relates to a containing system.

### BACKGROUND ART

A container for containing a material, particularly, in a powder form, is configured to discharge a contained material by using a pump.

As the material contained in the container is discharged, an internal pressure in a tank is rapidly lowered and thus the tank is compressed, which may cause damage to the tank.

Furthermore, a container containing powder is often fixedly provided in a vehicle for carrying containers. When the contained material is carried by using other transportation means, for example, a vessel, the material contained in the container is all discharged and then moved to other transportation means. During storage, the powder material needs to be contained in a separate storage horn apparatus.

### DESCRIPTION OF EMBODIMENTS

### Technical Problem

Provided is a containing system which may facilitate discharge of a contained material and improve efficiency of discharge.

Provided is a containing system which may prevent damage of a tank during discharge of a contained material.

### Solution to Problem

According to an aspect of the present disclosure, a containing system includes a first frame structure, a plurality of first discharge units in the first frame structure, extending in a first direction, and fixedly coupled to the first frame structure in a second direction perpendicular to the first direction, a second frame structure detachably coupled to the first frame structure in the first direction, a first containing unit fixedly supported on the second frame structure and spaced apart from the first frame structure, a second containing unit connected to the first containing unit and spaced apart from the first frame structure, a plurality of second discharge units connected to the second containing unit, aligned with the first discharge units in the first direction, and spaced apart from the first discharge units, and a pressure control unit connected to the first containing unit and controlling a first air pressure in the first containing unit to counterbalance a second air pressure outside the first containing unit.

The containing system may further include an aligner interposed between the first frame structure and the second frame structure.

The containing system may further include a transfer unit spaced apart from the first discharge unit in the first direction.

A first width of one end of the first discharge unit adjacent to the second discharge unit in the first direction may be greater than a second width of other end of the first discharge unit.

The pressure control unit may include a pipe assembly extending toward inside of the first containing unit and capable of being open or closed.

The pressure control unit may include a valve assembly provided on an outer wall of the first containing unit and generating a flow of fluid from outside of the first containing unit toward inside of the first containing unit when the first air pressure is less than the second air pressure.

The second containing unit may include a plurality of cone units, each of the cone units narrowing downwardly in the first direction, and an inclination angle of each of the cone units with respect to ground may be about 25° or greater and about 80° or less.

According to another aspect of the present disclosure, a containing system includes a first frame structure, a plurality of first discharge units provided in the first frame structure, extending in a first direction, and fixedly coupled to the first frame structure in a second direction perpendicular to the first direction, a second frame structure detachably coupled to the first frame structure in the first direction, a first containing unit fixedly supported on the second frame structure and spaced apart from the first frame structure, a second containing unit connected to the first containing unit and spaced apart from the first frame structure, and a plurality of second discharge units connected to the second containing unit, aligned to the first discharge units in the first direction, and spaced apart from the first discharge units.

The containing system may further include an aligner interposed between the first frame structure and the second frame structure.

The containing system may further include a transfer unit spaced apart from the first discharge unit in the first direction.

A first width of one end of the first discharge unit adjacent to the second discharge unit in the first direction may be greater than a second width of other end of the first discharge unit.

The second containing unit may include a plurality of cone units, each of the cone units narrowing downwardly in the first direction, and an inclination angle of each of the cone units with respect to ground may be about 25° or greater and about 80° or less.

### Advantageous Effects of Disclosure

According to the present disclosure, an unloading job of a material in the containing unit may be simplified and easier.

When the contained material is discharged and thus the air pressure in the containing unit is lowered, the internal air pressure is balanced with the external air pressure, and thus the contraction of the containing unit may be prevented and damage to the containing unit according thereto may be prevented.

Since the air pressure of the containing unit is controllable, there is no need to particularly increase the thickness of the containing unit. Accordingly, the weight of the containing unit may be reduced and the capacity of the containing unit may be increased.

The material contained in the containing unit may be easily discharged, thereby improving discharge efficiency.

A plurality of containing units may be easily stacked in the vertical and/or horizontal directions. Accordingly, since the containers are transported by being loaded on general container vessels and/or trains, logistics costs may be reduced.

During storing, since the contained material can be continuously kept in the containing unit without being discharged from the containing unit and stored in a separate storage device, logistics costs and storage costs may be reduced much.

### BRIEF DESCRIPTION OF DRAWINGS

FIG. 1 is a side view of a containing system according to an embodiment;

FIG. 2 is a plan view of a first frame structure of FIG. 1;

FIG. 3 is a rear view of the containing system of FIG. 1;

FIG. 4 is a rear view of a containing system according to another embodiment;

FIG. 5 illustrates a portion of the containing system of FIG. 4; and

FIG. 6 is a rear view of a containing system according to another embodiment.

### BEST MODE

Reference will now be made in detail to embodiments, examples of which are illustrated in the accompanying drawings. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. In some embodiments, well-known processes, well-known structures and well-known technologies will not be specifically described in order to avoid ambiguous interpretation of the present invention. Like reference numerals refer to like elements throughout the specification.

An expression used in the singular encompasses the expression of the plural, unless it has a clearly different meaning in the context.

In the following embodiments, it will be further understood that the terms “comprises” and/or “comprising,” when used in this specification, specify the presence of stated components, steps, operations, and/or elements, but do not preclude the presence or addition of one or more other components, steps, operations, elements, and/or groups thereof.

In the following embodiments, it will be understood that when an element or layer is referred to as being “on” another element or layer, the element or layer can be directly on another element or layer or intervening elements or layers.

When a certain embodiment may be implemented differently, a specific process order may be performed differently from the described order. For example, two consecutively described processes may be performed substantially at the same time or performed in an order opposite to the described order.

Sizes of components in the drawings may be exaggerated for convenience of explanation. In other words, since sizes and thicknesses of components in the drawings are arbitrarily illustrated for convenience of explanation, the following embodiments are not limited thereto.

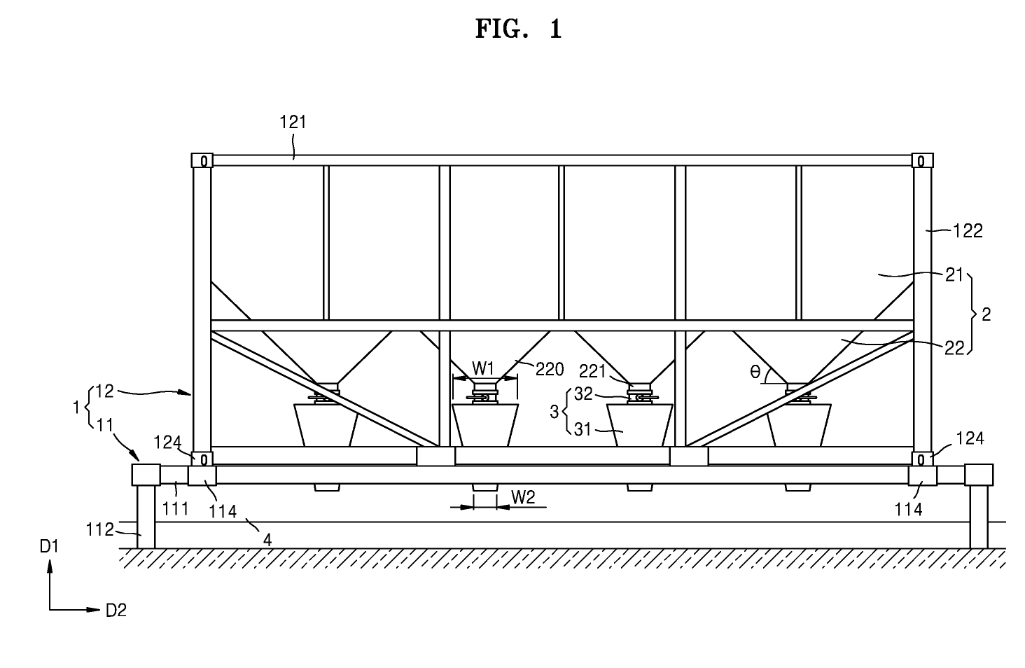

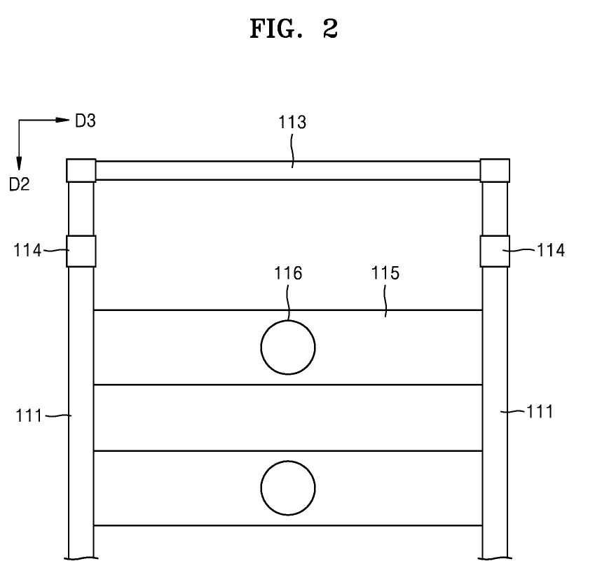

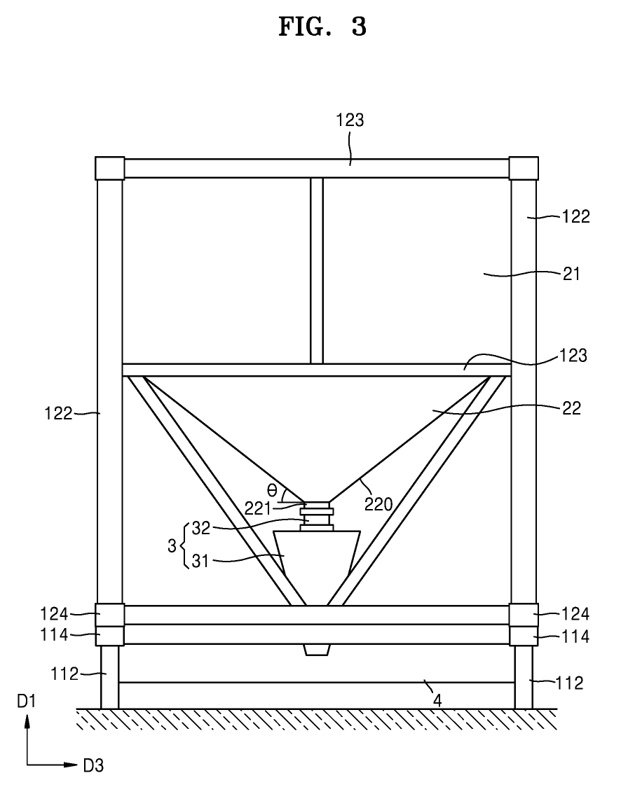

FIG. 1 is a side view of a containing system according to an embodiment. FIG. 2 is a plan view of a first frame structure of FIG. 1. FIG. 3 is a rear view of the containing system of FIG. 1.

First, a containing system according to the present embodiment may include a frame structure 1, a containing unit 2, and a discharge unit 3.

The frame structure 1 may include a first frame structure 11 and a second frame structure 12 capable of coupling each other.

The first frame structure 11 has a structure in which (1-1)th frames 111 spaced apart from the ground in a first direction D1 and horizontally extending in a second direction D2 that is perpendicular to the first direction D1 and (1-2)th frames 112 separating the (1-1)th frames 111 from the ground by a certain distance are coupled to each other.

Referring to FIG. 2, the (1-1)th frames 111 are connected with each other at an end portion thereof by a (1-3)th frame 113 extending in a third direction D3. A plurality of (1-4)th frames 115 extending in the third direction D3 may be arranged between the (1-1)th frames 111 facing each other. The opposite ends of the (1-4)th frames 115 may be coupled to the (1-1)th frames 111. The (1-4)th frames 115 may be formed in a panel shape as illustrated in FIG. 2, but the present disclosure is not limited thereto and the (1-4)th frames 115 may be formed by a pair of frames extending parallel to each other. An opening 116 in which a first discharge unit to be described later is provided may be provided on the (1-4)th frames 115. The opening 116 may be located at a position aligned with a second discharge unit.

A plurality of aligners 114 for aligning the second frame structure 12 may be provided on the (1-1)th frames 111. Coupling units 124 of the second frame structure 12 are placed on the aligners 114. The aligners 114 and the coupling units 124 in an aligned state may be coupled by separate coupling means. When the coupling means are removed, the aligners 114 and the coupling units 124 may be separated from each other.

The second frame structure 12 may include (2-1)th frames 121 extending in the second direction D2, (2-2)th frames 122 extending in the first direction D1, and (2-3)th frames 123 extending in the third direction D3. Each of the (2-1)th frames 121 to the (2-3) frames 123 are provided in multiple numbers, forming a frame of a rectangular parallelepiped as illustrated in FIGS. 1 and 3. The number of the respective frames may be dynamically determined considering a load of the container supported by the second frame structure 12, loading and transport of a plurality of containers, wind, etc.

The coupling units 124 may be provided at at least one apex of the second frame structure 12 and coupled to the first frame structure 11. The coupling units 124 may be used for coupling with other container and transport. The coupling units 124 may be coupled to each other by a separate coupling means. The coupling units 124 may have a structure capable of coupling with a cargo container having another shape for loading on other cargo container that is not the container according to the present embodiment. This may be identically applied to all other embodiments.

The containing unit 2 may include a first containing unit 21 and a second containing unit 22.

The first containing unit 21 and the second containing unit 22 may be connected to each other. The first containing unit 21 may be located above in the first direction D1, whereas the second containing unit 22 may be located under the first containing unit 21 in the first direction D1. The first containing unit 21 and the second containing unit 22 may be integrally formed of the same material, but the present disclosure is not limited thereto and they may be separately manufactured and then coupled by welding. This may be identically applied to all other embodiments.

The first containing unit 21 may be supported by the second frame structure 12. To this end, the first containing unit 21 may have the above rectangular parallelepiped shape. The height of the first containing unit 21 in the first direction D1 may be approximately half the height of the second frame structure 12 in the first direction D1, Accordingly, the first containing unit 21 may extend from an upper end of the second frame structure 12 in the first direction D1 to a position that is approximately half the height of the second frame structure 12 in the first direction D1. A length of the first containing unit 21 in the second direction D2 and a width of the first containing unit 21 in the third direction D3 are sufficiently long so as to be contacted and supported by the second frame structure 12. This may be identically applied to all other embodiments.

The second containing unit 22 may extend downwardly from a lower end of the first containing unit 21 in the first direction D1. The second containing unit 22 may include a plurality of cone units 220, each having a funnel shape and downwardly narrowing in the first direction D1. According to an embodiment, four cone units 220 may be sequentially arranged in the second direction D2. The number of the cone units 220 may be designed considering a total volume of the containing unit 2.

According to an embodiment, each of the cone units 220 may be inclined at a certain inclination angle θ with respect to the ground. The inclination angle θ may be about 25° or greater. The material contained in the containing unit 2 is naturally discharged downwardly due to the inclination angle θ of each of the cone units 220 of the second containing unit 22. When the inclination angle θ is about 25° or greater, a smooth and natural discharge of the contained material may be performed. In other words, as described below, when the second discharge unit 32 is open to discharge the contained material in the containing unit 2, the contained material may be naturally and smoothly discharged without using a separate discharge air pump only when the inclination angle θ of each of the cone units 220 is about 25° or greater. When an air pump is used to discharge the contained material, a large amount of dust may be generated during the discharge. According to the present embodiment, when the inclination angle θ is about 25° or greater, the contained material may be naturally discharged and thus the generation of dust may be reduced.

The inclination angle θ may be designed in relation with the number of the cone units 220. When the inclination angle θ exceeds 80°, the number of the cone units 220 excessively increases so that adjustment of the number of discharge holes, a discharge amount, and/or a discharged rate may be difficult. Accordingly, the inclination angle θ may be about 80° or less. Also, the inclination angle θ may be variously designed according to the type of a contained material. For example, an inclination angle θ when the contained material is grains may be different from, for example, greater than, an inclination angle θ when the contained material is minerals. This is because the size of a grain is generally small and a frictional force between grains and a frictional force between grains and an inner surface of each of the cone units 220 are large, compared to a case of a mineral.

Although, in the drawings, the inclination angle θ is illustrated to be an angle formed between an outer surface of each of the cone units 220 and the ground, the present disclosure is not limited thereto and, in consideration that it is related to the facility of discharge of an internally contained material, strictly speaking, the inclination angle θ may be an angle between the inner surface of each of the cone units 220 and the ground.

The structure of the cone units 220 described above may be identically applied to all other embodiments described below.

Connection pipes 221 may extend downwardly in the first direction D1 from a lower end of each of the cone units 220. The connection pipes 221 may extend parallel with each other to the first direction D1. As the second discharge units 32 are provided at lower ends of the connection pipes 221, the lower ends of the connection pipes 221 may be open or closed. The material contained in the containing unit 2 may be discharged through the connection pipes 221 and the second discharge units 32.

A plurality of first discharge units 31 are arranged in the second direction D2 in a lower portion of the second containing unit 22 in the first direction D1. A first width W1 of one end of the first discharge unit 31 adjacent to the second discharge unit 32 in the first direction D1 may be greater than a second width W2 of the other end of the first discharge unit 31. Accordingly, the contained material from the second discharge unit 32 may be smoothly discharged toward the first discharge unit 31.

A transfer unit 4 may be further provided at a position spaced apart from the first discharge unit 31 in the first direction D1. The transfer unit 4 is provided to transfer the contained material discharged through the first discharge unit 31 to other external process. For example, a conveyor apparatus may be used as the transfer unit 4.

According to the containing system of the present embodiment, since the containing unit 2 coupled to the second frame structure 12 is coupled to the first frame structure 11, and the contained material in the containing unit 2 may be directly discharged through the second discharge unit 32 and the first discharge unit 31, a loading and unloading job of a material in the containing unit 2 may be simplified and easy. Furthermore, since the containing unit 2 is fixed to the second frame structure 12, the containing units 2 unloaded from vessels may be kept in multiple stacks at a site due to the second frame structure 12. Thus, the second frame structure 12 is coupled to the first frame structure 11 only when an internally contained material is discharged. Accordingly, goods, in particular, a contained material in a powder form, may be kept and transferred effectively at very low costs. To this end, the containing unit 2 is located inside the second frame structure 12 and is not exposed outside the second frame structure 12.

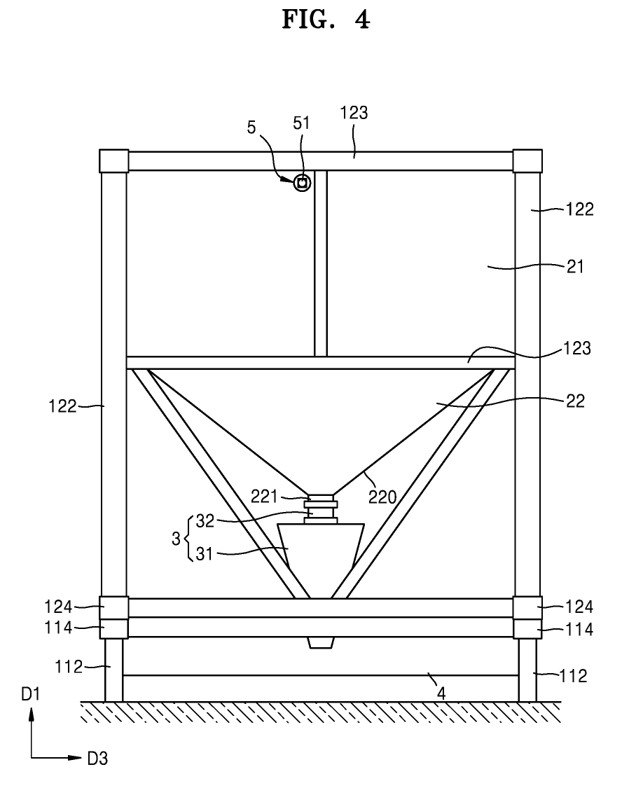

A containing system according to another embodiment, as illustrated in FIG. 4, may include a pressure control unit 5. The pressure control unit 5 may be connected to the first containing unit 21 and controls a first air pressure in the first containing unit 21 to approximately counterbalance a second air pressure outside the first containing unit 21.

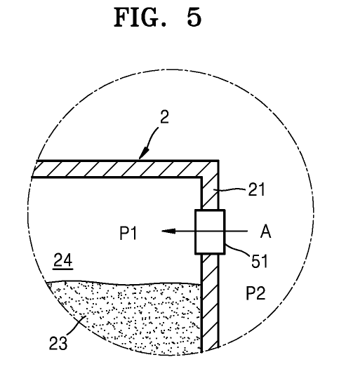

The pressure control unit 5 may be provided on an outer side wall of the first containing unit 21, that is, on an outer side wall of the first containing unit 21 in an end portion thereof in the second direction D2. The pressure control unit 5 may be provided in an upper portion of the first containing unit 21 to be adjacent to the (2-3)th frames 123 at the top of the second frame structure 12. As illustrated in FIG. 5, when a contained material 23 is contained in the containing unit 2, a space portion 24 where the contained material 23 is not filled may be formed in the containing unit 2. The pressure control unit 5 may be located facing the space portion 24. Accordingly, when a material is contained in the containing unit 2, the contained material may not be contacted by the pressure control unit 5. Alternatively, the pressure control unit 5 may be provided on an upper outer wall of the first containing unit 21.

The material contained in the containing unit 2 may be discharged through the connection pipe 221, the second discharge unit 32, and the first discharge unit 31. In this case, a first air pressure in the containing unit 2 may be rapidly decreased. Accordingly, the outer wall of the containing unit 2 may be inwardly compressed and distorted. In this state, the first air pressure in the first containing unit 21 is approximately balanced with the second air pressure outside the first containing unit 21 by the pressure control unit 5, the containing unit 2 may be prevented from being damaged. In the present specification, that the first air pressure and the second air pressure are balanced does not necessarily signify that the first air pressure and the second air pressure are the same. Even when there is a difference between the first air pressure and the second air pressure, such a difference may be interpreted to be a difference in the pressure such that the containing unit 2 is not compressed and distorted due to the difference. This may be applied to all other embodiments in the present specification.

According to an embodiment, the pressure control unit 5 may include a valve assembly 51. The valve assembly 51 may be open or closed when there is a pressure difference over a particular value. A pressure opening/closing type check valve assembly or a relief valve assembly may be used as the pressure control unit 5. Referring to FIG. 5, when a first air pressure P1 in the first containing unit 21 and a second air pressure P2 are the same, the valve assembly 51 maintains a closed state. When the first air pressure P1 is lower than the second air pressure P2, the valve assembly 51 generates a flow of fluid A from the outside of the first containing unit 21 into the first containing unit 21. Accordingly, the first air pressure P1 is approximately balanced with the second air pressure P2 so that the containing unit 2 may be prevented from being damaged.

The above embodiment may be applied to other embodiments of the present specification.

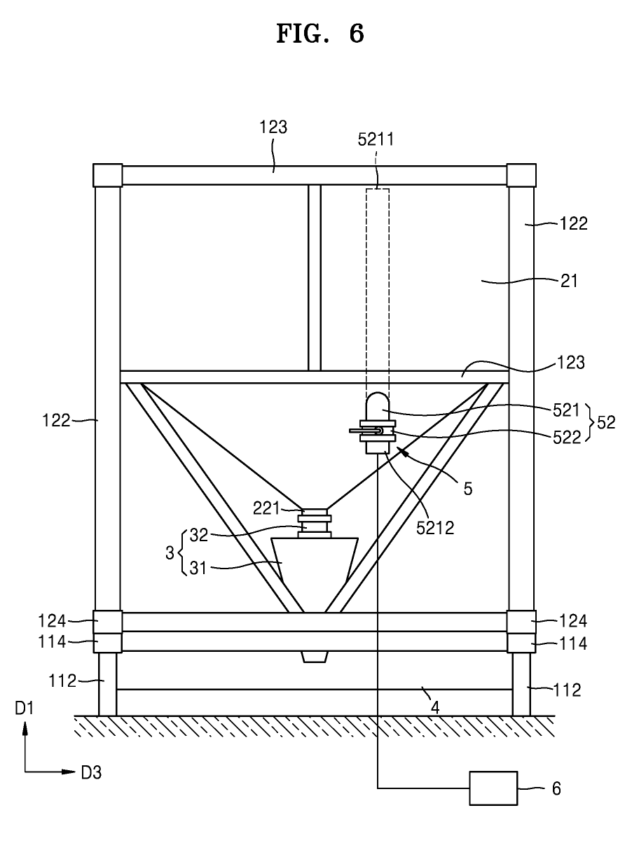

FIG. 6 is a rear view of a containing system according to another embodiment. In the embodiment illustrated in FIG. 6, like reference numerals refer to like elements, redundant descriptions on the like elements are omitted, and only differences are mainly discussed.

In the embodiment illustrated in FIG. 6, the pressure control unit 5 may include a pipe assembly 52. The pipe assembly 52 may include a pipe unit 521 and an opening/closing value 522.

The pipe unit 521 is inserted into the inside of the first containing unit 21 from the second containing unit 22. In detail, the pipe unit 521 may be coupled to the second containing unit 22. A first end 5211 of the pipe unit 521 may extend to an inner upper end of the first containing unit 21 to be slightly deviated from the inner upper end of the first containing unit 21. For example, when the inner upper end of the first containing unit 21 is formed to have a curvature, the first end 5211 of the pipe unit 521 extends to touch the inner upper end of the first containing unit 21, the first end 5211 of the pipe unit 521 and the inner upper end of the first containing unit 21 may be spaced apart from each other to a certain degree due to the curvature of the inner upper end of the first containing unit 21.

A second end 5212 of the pipe unit 521 is exposed to the outside of the second containing unit 22. The opening/closing value 522 is provided adjacent to the second end 5212 so that the second end 5212 may be selectively open or closed.

Accordingly, as in the above-described embodiments, when the first air pressure P1 in the first containing unit 21 and the second air pressure P2 are the same, the second end 5212 of the pipe unit 521 is maintained in a closed state. When the first air pressure P1 is lower than the second air pressure P2, in other words, the contained material is discharged from the containing unit 2, the opening/closing value 522 is open so that the flow of fluid from the outside of the first containing unit 21 to the inside of the first containing unit 21 is generated. Accordingly, the first air pressure P1 is approximately balanced with the second air pressure P2 so that to the containing unit 2 may be prevented from being damaged. The opening/closing value 522 may be open or closed by a user's manipulation, but the present disclosure is not limited thereto and the opening/closing value 522 may be open, engaged with the opening of the second discharge unit 32. The opening/closing value 522 may be capable of being open/closed when a pressure difference is over a particular value. For example, a pressure opening/closing type check valve assembly or a relief valve assembly may be employed as the opening/closing value 522. Accordingly, when the first air pressure P1 in the first containing unit 21 and the second air pressure P2 are the same, a closed state is maintained. When the first air pressure P1 is lower than the second air pressure P2, opening/closing value 522 is open so that a flow of fluid from the outside of the first containing unit 21 into the inside of the first containing unit 21 may be generated.

Alternatively, a pressing unit 6 may be further connected to the second end 5212. An air pump may be used as the pressing unit 6. A fluid may be supplied to the inside of the first containing unit 21 via the pipe unit 521. Accordingly, when a pressure difference from the outside of the containing unit 2 is abruptly generated, the pressure difference is initially removed so that to the containing unit 2 may be prevented from being damaged.

The above embodiment may be applied to other embodiments of the present specification.

Alternatively, the embodiment of FIG. 6 may be additionally coupled to the embodiment of FIG. 4. Accordingly, when a user discharges a contained material, a difference in the pressure between the inside and outside of the containing unit 2 is smoothly removed so that the containing unit 2 may be prevented from being damaged.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

1. A containing system comprising:
a first frame structure;
a plurality of first discharge units provided in the first frame structure, extending in a first direction, and fixedly coupled to the first frame structure in a second direction perpendicular to the first direction;
a second frame structure detachably coupled to the first frame structure in the first direction;
a first containing unit fixedly supported on the second frame structure and spaced apart from the first frame structure;
a second containing unit connected to the first containing unit and spaced apart from the first frame structure;
a plurality of second discharge units connected to the second containing unit, aligned with the first discharge units in the first direction, and spaced apart from the first discharge units; and
a pressure control unit connected to the first containing unit and controlling a first air pressure in the first containing unit to counterbalance a second air pressure outside the first containing unit.

2. The containing system of claim 1, further comprising an aligner interposed between the first frame structure and the second frame structure.

3. The containing system of claim 1, further comprising a transfer unit spaced apart from the first discharge unit in the first direction.

4. The containing system of claim 1, wherein a first width of one end of the first discharge unit adjacent to the second discharge unit in the first direction is greater than a second width of other end of the first discharge unit.

5. The containing system of claim 1, wherein the pressure control unit comprises a pipe assembly extending toward inside of the first containing unit and capable of being open or closed.

6. The containing system of claim 1, wherein the pressure control unit comprises a valve assembly provided on an outer wall of the first containing unit and generating a flow of fluid from outside of the first containing unit toward inside of the first containing unit when the first air pressure is less than the second air pressure.

7. The containing system of claim 1, wherein the second containing unit comprises a plurality of cone units, each of the cone units narrowing downwardly in the first direction, and an inclination angle of each of the cone units with respect to ground is about 25° or greater and about 80° or less.

8. A containing system comprising:
a first frame structure;
a plurality of first discharge units provided in the first frame structure, extending in a first direction, and fixedly coupled to the first frame structure in a second direction perpendicular to the first direction;
a second frame structure detachably coupled to the first frame structure in the first direction;
a first containing unit fixedly supported on the second frame structure and spaced apart from the first frame structure;
a second containing unit connected to the first containing unit and spaced apart from the first frame structure; and
a plurality of second discharge units connected to the second containing unit, aligned to the first discharge units in the first direction, and spaced apart from the first discharge units.

9. The containing system of claim 8, further comprising an aligner interposed between the first frame structure and the second frame structure.

10. The containing system of claim 8, further comprising a transfer unit spaced apart from the first discharge unit in the first direction.

11. The containing system of claim 8, wherein a first width of one end of the first discharge unit adjacent to the second discharge unit in the first direction is greater than a second width of other end of the first discharge unit.

12. The containing system of claim 8, wherein the second containing unit comprises a plurality of cone units, each of the cone units narrowing downwardly in the first direction, and an inclination angle of each of the cone units with respect to ground is about 25° or greater and about 80° or less.
